(19) United States
(12) Patent Application Publication
(10) Pub. No.: US 2022/0341743 A1
(43) Pub. Date: Oct. 27, 2022

(54) METHOD AND SYSTEM FOR AVOIDANCE MANAGEMENT

(71) Applicant: AT&T Intellectual Property I, L.P., Atlanta, GA (US)

(72) Inventors: Nigel Bradley, Canton, GA (US); Rashmi Palamadai, Naperville, IL (US); Eric Zavesky, Austin, TX (US); Robert Koch, Norcross, GA (US); Ari Craine, Marietta, GA (US)

(73) Assignee: AT&T Intellectual Property I, L.P., Atlanta, GA (US)

(21) Appl. No.: 17/239,784

(22) Filed: Apr. 26, 2021

(51) Int. Cl. G01C 21/34

(52) U.S. Cl. CPC G01C 21/3461; G01C 21/3484; G01C 21/3492

(57) ABSTRACT

Aspects of the subject disclosure may include, for example, receiving a user input that defines an avoidance rule and that associates the avoidance rule with a plurality of applications installed on a user device, where the avoidance rule relates to content, associating the avoidance rule with the applications responsive to receiving the user input, monitoring data received at the applications, based on detecting that a first portion of first data received at a first application satisfies the avoidance rule, preventing the first application from presenting the first portion of the first data on the user device, and based on identifying, according to information received at the first application or a second application, that a discussion or event occurring at a geographic location satisfies the avoidance rule, causing a first notification regarding the discussion or event to be presented by the user device. Other embodiments are disclosed.

### FIELD OF THE DISCLOSURE

The subject disclosure relates to avoidance management.

### BACKGROUND

As a user interacts in the physical and digital worlds, the user may be provided with data/content, or come upon undesired people (e.g., contacts), environments, situations, or the like, that the user wishes to avoid.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a system functioning within, or operatively overlaid upon, the communications network of FIG. 1 in accordance with various aspects described herein.

FIGS. 2B and 2C are block diagrams illustrating example, non-limiting embodiments of user interfaces associated with the system of FIG. 2A in accordance with various aspects described herein.

FIGS. 2D-2H are block diagrams illustrating example, non-limiting embodiments of respective systems functioning within, or operatively overlaid upon, the system of FIG. 2A and/or the communications network of FIG. 1 in accordance with various aspects described herein.

FIG. 2J depicts an illustrative embodiment of a method in accordance with various aspects described herein.

FIG. 3 is a block diagram illustrating an example, non-limiting embodiment of a virtualized communications network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

Presently, users lack a mechanism that allows them to define and use criteria for avoiding content, contacts (e.g., people), and other subject matter or situations when interacting in the physical and/or digital worlds. Providing a solution that enables users to utilize a common (or the same) set of criteria for both the physical and digital world— i.e., that enables users to avoid people, topics, etc. not only in digital environments, but also in physical environments—would enhance overall avoidance management.

The subject disclosure describes, among other things, illustrative embodiments for providing avoidance management for a user in physical and/or digital environments based on avoidance criteria. Exemplary embodiments described herein provide an avoidance manager platform (e.g., a tool) that enables a user to select, or otherwise define, avoidance criteria for avoiding content, contacts (e.g., people), and other subject matter or situations in the physical and digital worlds. In various embodiments, the avoidance manager platform may (e.g., based upon user input) monitor and analyze data/content received at applications installed on a user device, and determine whether to block/remove portion(s) of the data/content and/or provide notifications regarding the data/content to the user, as described herein. In some embodiments, the avoidance manager platform may be capable of inferring or learning avoidance criteria for a user over time. Other embodiments are described in the subject disclosure.

One or more aspects of the subject disclosure include a device, comprising a processing system including a processor, and a memory that stores executable instructions that, when executed by the processing system, facilitate performance of operations. The operations can include receiving a user input that defines an avoidance criterion, wherein the avoidance criterion relates to an undesirable physical environment condition, and wherein the avoidance criterion is usable to restrict content, relating to physical locations that have the undesirable physical environment condition, from being presented on the device. Further, the operations can include associating the avoidance criterion with a plurality of applications installed on the device, detecting first content received at a first application of the plurality of applications, and analyzing the first content responsive to the detecting the first content. Further, the operations can include determining, based on the analyzing the first content, that a first portion of the first content satisfies the avoidance criterion, and preventing the first application from presenting the first portion of the first content on the device based on the determining that the first portion of the first content satisfies the avoidance criterion.

One or more aspects of the subject disclosure include a non-transitory machine-readable medium, comprising executable instructions that, when executed by a processing system of a user device including a processor, facilitate performance of operations. The operations can include detecting a user input that defines an avoidance rule, wherein the avoidance rule relates to a first contact, and wherein the avoidance rule is usable to identify a physical presence of the first contact and to prevent data associated with the first contact from being presented on the user device. Further, the operations can include associating the avoidance rule with a plurality of applications installed on the user device, and based on identifying, according to information received at a first application of the plurality of applications, the physical presence of the first contact within a threshold distance from the user device, causing a first notification regarding the first contact to be presented on the user device to enable a user of the user device to avoid the first contact. Further, the operations can include based on determining that first data, received at the first application or at a second application of the plurality of applications, is associated with the first contact, preventing the first data from being presented on the user device.

One or more aspects of the subject disclosure include a method. The method can comprise receiving, by a processing system of a user device including a processor, a user input that defines an avoidance rule and that associates the avoidance rule with a plurality of applications installed on the user device, wherein the avoidance rule relates to content. Further, the method can include associating, by the processing system, the avoidance rule with the plurality of applications responsive to the receiving the user input, and monitoring, by the processing system according to the avoidance rule, data received at the plurality of applications. Further, the method can include, based on detecting, from the monitoring, that a first portion of first data received at a first application of the plurality of applications satisfies the avoidance rule, preventing, by the processing system, the first application from presenting the first portion of the first data on the user device. Further, the method can include, based on identifying, according to information received at the first application or a second application of the plurality of applications, that a discussion or event occurring at a geographic location satisfies the avoidance rule, causing, by the processing system, a first notification regarding the discussion or event to be presented by the user device to enable a user of the user device to avoid the discussion or event.

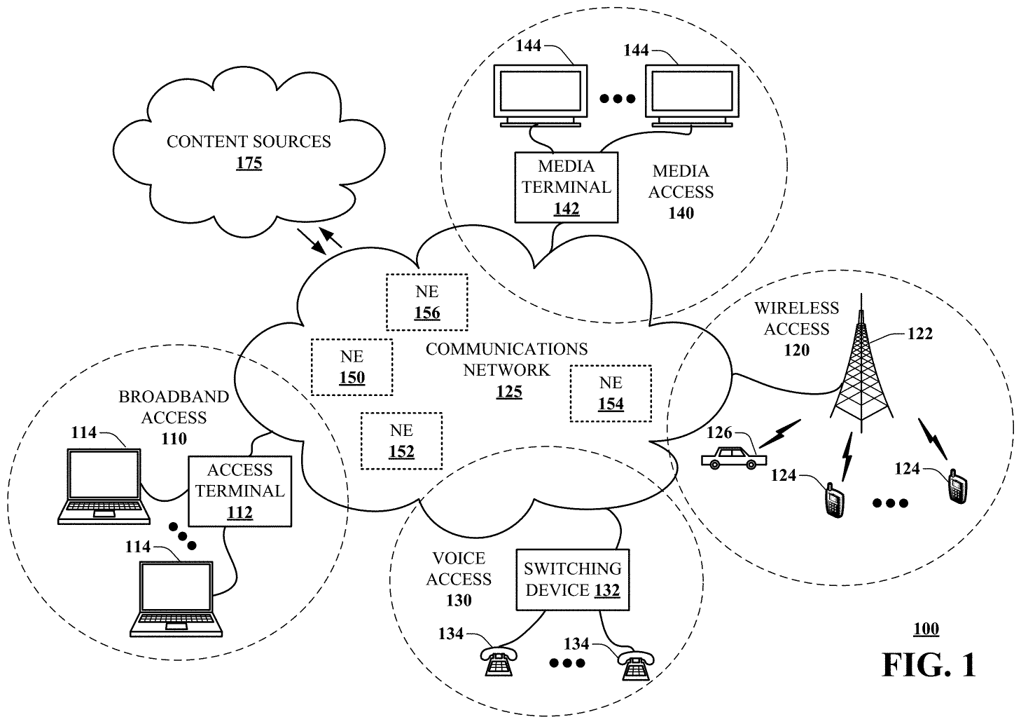

Referring now to FIG. 1, a block diagram is shown illustrating an example, non-limiting embodiment of a system 100 in accordance with various aspects described herein. For example, system 100 can facilitate, in whole or in part, providing avoidance management for a user in physical and/or digital environments based on avoidance criteria. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communications network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

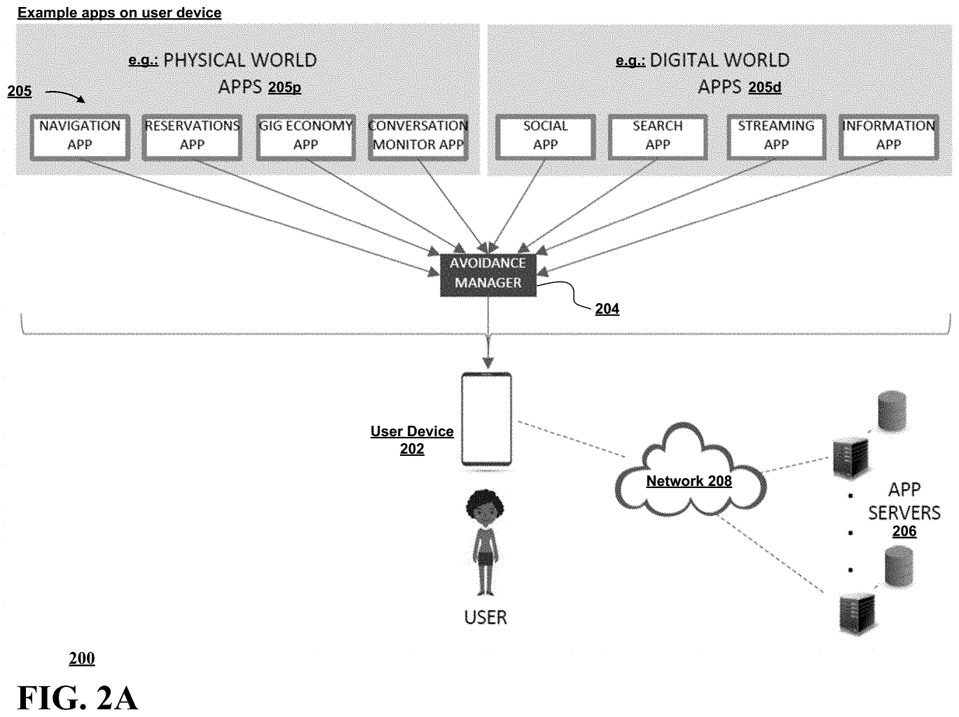

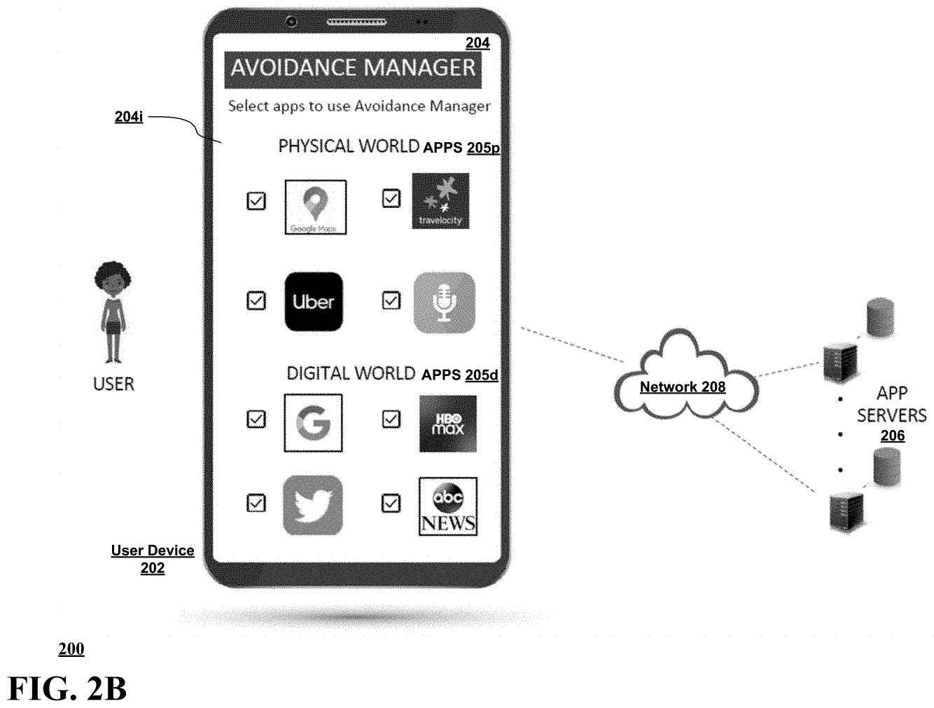

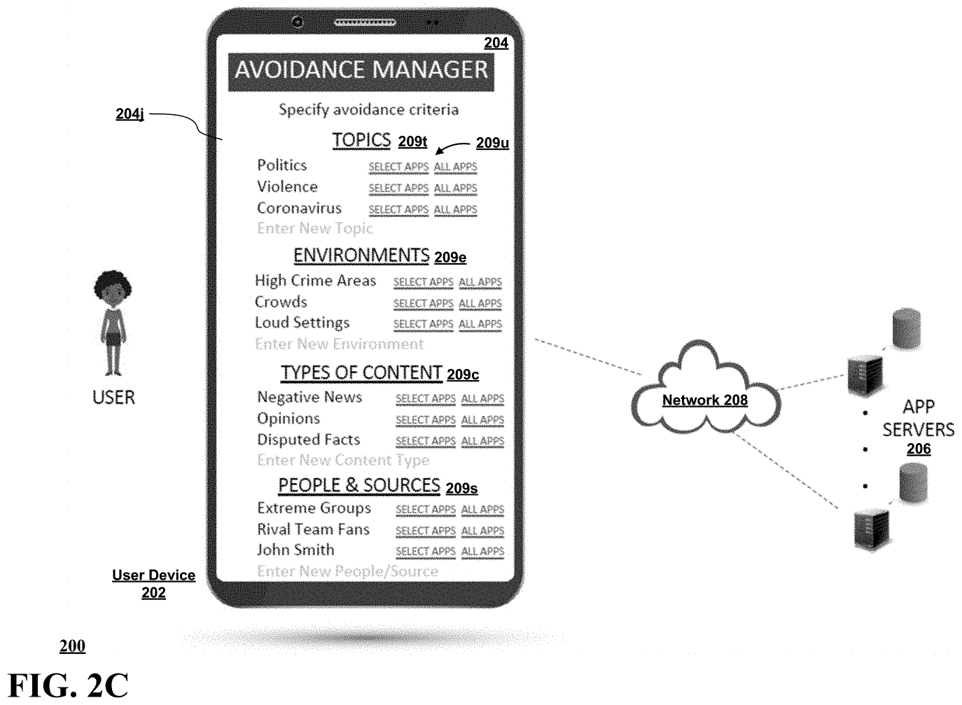

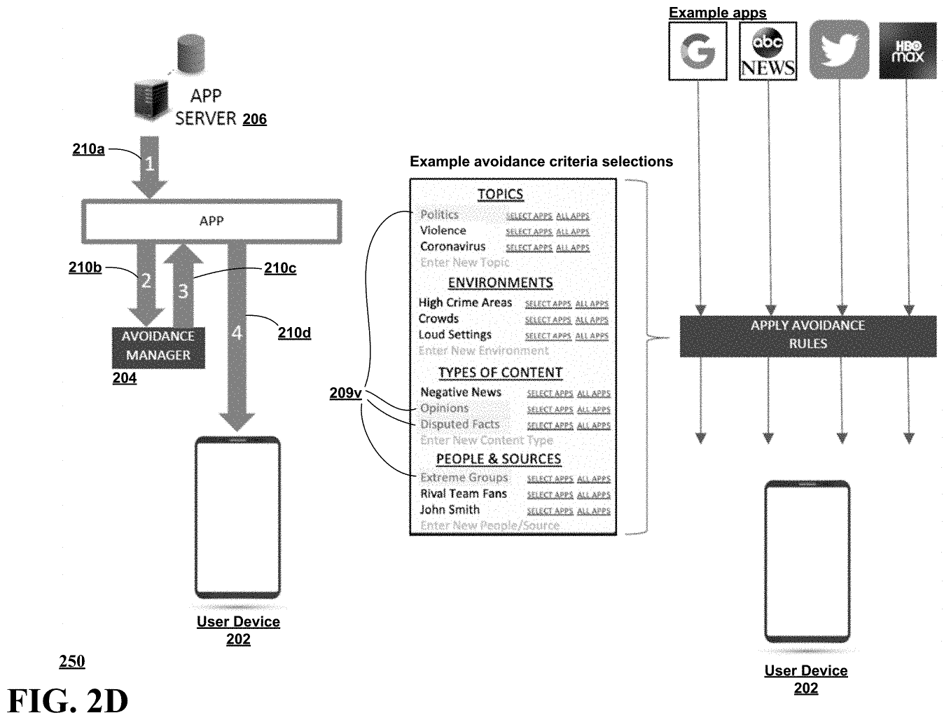

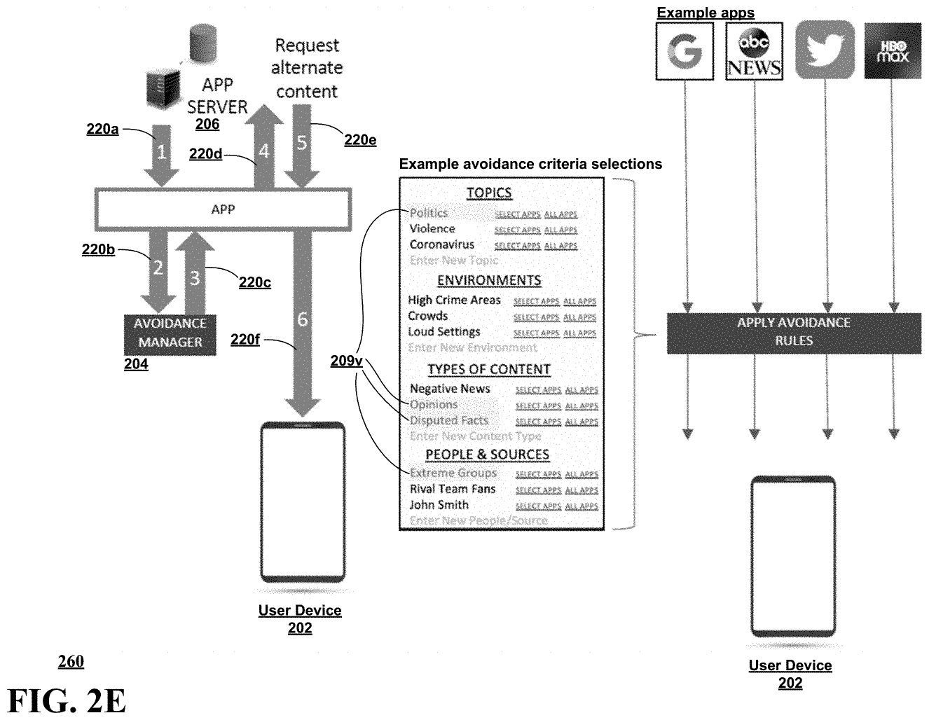

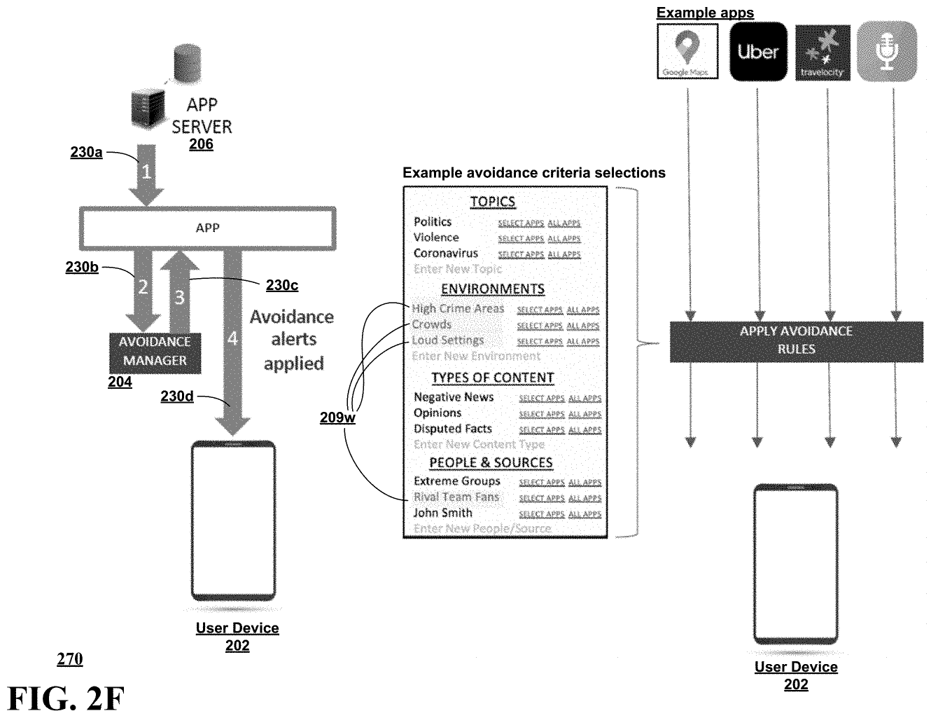

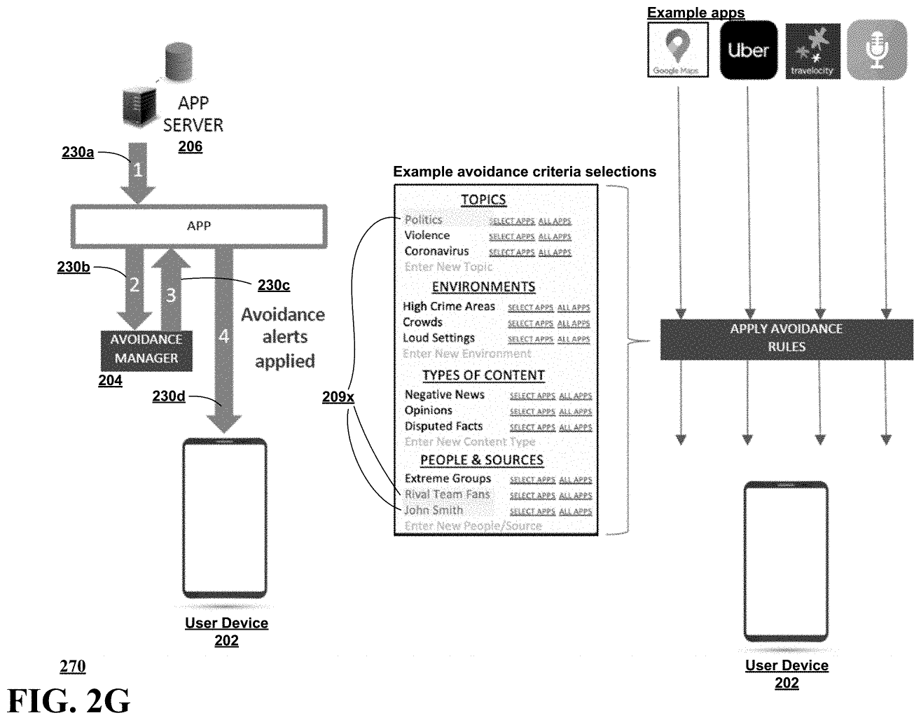

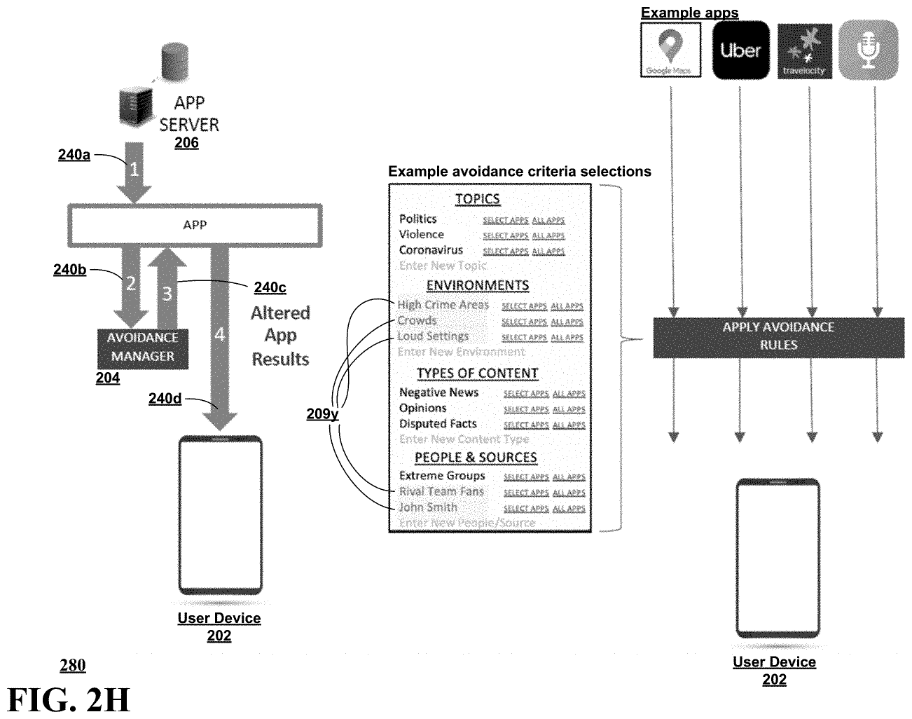

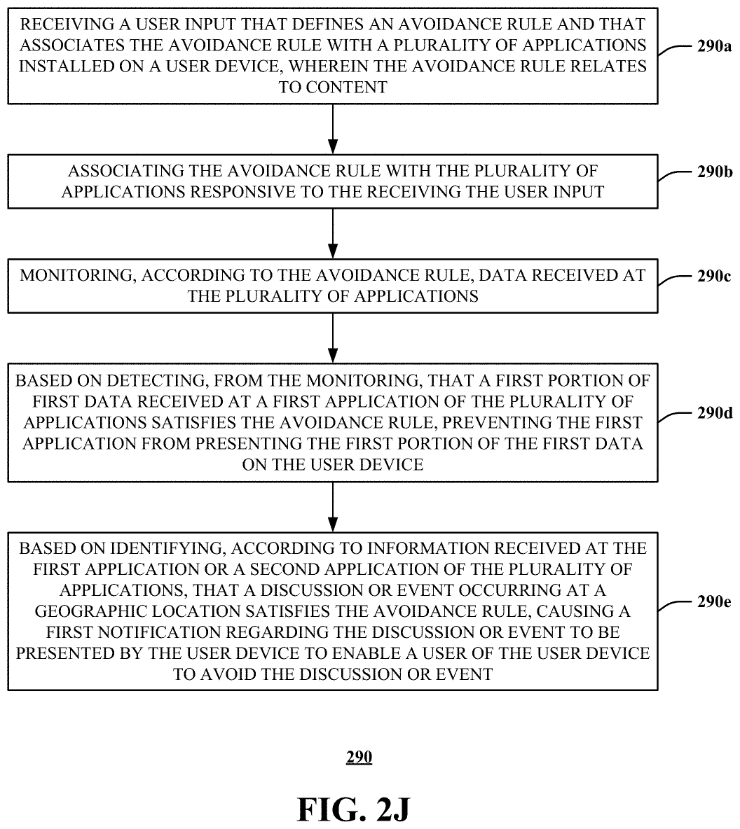

FIG. 2A is a block diagram illustrating an example, non-limiting embodiment of a system 200 functioning within, or overlaid upon, the communications network 100 of FIG. 1 in accordance with various aspects described herein.

As shown in FIG. 2A, the system 200 can include a user device 202. For example, the device 202 can include a communication and/or computing device, such as a mobile phone (e.g., a smart phone, a radiotelephone, etc.), a desktop computer, a laptop computer, a tablet computer, a handheld computer, a display device, a gaming device, a wearable communication device (e.g., a smart wristwatch, a pair of smart eyeglasses, XR gear (e.g., a pair of AR, VR, MR glasses, a headset, headphones, and/or the like), etc.), a similar type of device, or a combination of some or all of these devices.

As depicted in FIG. 2A, the user device 202 may be equipped with an avoidance manager platform 204. The avoidance manager platform 204 can include an application or software package installed, or otherwise operating, on the user device 202. In certain embodiments, the avoidance manager platform 204 may be implemented in a network, such as a network 208. In some embodiments, the avoidance manager platform 204 (e.g., whether implemented as a network-based platform or not) may be executed and synchronized across multiple devices. In one or more embodiments, the avoidance manager platform 204 may be executed on and/or configurable via certain devices (e.g., one or more parents' user devices or the like), but not other devices (e.g., a child's user device or the like). In exemplary embodiments, the avoidance manager platform 204 may be configured to provide avoidance management for a user in physical and/or digital environments based on avoidance criteria. In some embodiments, the avoidance manager platform 204, when executed by one or more processors of the user device 202, may cause the one or more processors to present user interface(s) (e.g., various user interface screens, including user interface screens 204i and 204j described in more detail below with respect to FIGS. 2B and 2C) that enable a user to select, or define, avoidance criteria for one or more other applications (or apps) installed on the user device 202, and may cause the one or more processors to manage data flow, or presentation of data relating to such other apps, based on the avoidance criteria.

An app may be a software program configured to run on the user device and provide a service for a user. Various apps may facilitate user interactions in (e.g., only in) the real (or physical) world—e.g., physical world apps 205p. For instance, a navigation app may provide navigational directions (e.g., in real-time or near real-time) that guide a user from one physical location to another. Other physical world-related apps include a reservation app (e.g., that facilitates making reservations at establishments, such as restaurants, hotels, etc.), a gig economy app (e.g., relating to in-person work or the like), a conversation monitoring app (e.g., for monitoring and/or servicing a user's voice-based commands), and/or the like. Some apps may involve (e.g., only involve) digital world interactions—e.g., digital world apps 205d. For example, a social media app may facilitate creation and/or sharing of information, ideas, or other forms of expression via a virtual network. Other digital world-related apps include a web browser (search) app, a media content (video/audio) streaming app, a communication app (e.g., a phone app, a chat/messaging app, etc.), a game app, an informational app, and/or the like. Certain apps may facilitate user interactions in both the physical world and the digital world. As an example, a shopping app may enable the user to conduct transactions with a merchant online (e.g., over the Internet or the like), while also enabling the user to arrange for an in-person pickup of purchased items at the merchant's physical location. Further, various of the aforementioned apps may also have aspects relating to both the physical and digital worlds.

As shown in FIG. 2A, the user device 202 and/or the apps may be communicatively coupled to one or more app servers 206 via the network 208. An app server 206 may correspond to, or otherwise be configured to communicate data with, an app installed on the user device 202. In various embodiments, an app server 206 may include one or more devices (e.g., server device(s) or the like) configured to provide one or more functions or capabilities, such as receiving, generating, storing, processing, and/or providing data relating to the corresponding app.

The network 208 may include one or more wired and/or wireless networks. For example, the network 208 may include a cellular network (e.g., a long-term evolution (LTE) network, a code division multiple access (CDMA) network, a 3G network, a 4G network, a 5G network, another type of next generation network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, and/or the like, and/or a combination of these or other types of networks.

It will be appreciated and understood that the system 200 can include any number/types of avoidance manager platforms, user devices, apps, app servers, and networks, and thus the number/types of avoidance manager platforms, user devices, apps, app servers, and networks shown in FIG. 2A is for illustrative purposes only.

In various embodiments, the avoidance manager platform 204 may function as a gatekeeper that controls delivery or presentation of data by apps that are managed by the avoidance manager platform 204. In exemplary embodiments, the avoidance manager platform 204 may apply criteria or rules—e.g., avoidance criteria or rules defined by the user and/or inferred based on historical usage data relating to the user—to identify data/content that is permitted to be delivered or presented to the user and/or data/content that is to be removed or blocked from being delivered or presented to the user. In some embodiments, a set of criteria (e.g., a single set of criteria) may be defined by the user to be applied across some or all of the apps that are selected to be associated with or managed by the avoidance manager platform 204, including both digital and physical world-related apps. In one or more embodiments, the avoidance manager platform 204 may be configurable to control delivery or presentation of data by apps across different user devices associated with different users. For example, the avoidance manager platform 204 may be configurable to control delivery or presentation of data by a particular social media app/platform, regardless of which user device (e.g., smartphones or the like of parents, children, etc.) in a household is used to access the social media app/platform.

Referring to FIG. 2B, the avoidance manager platform 204 may cause the user device 202 to present a user interface 204i that enables a user to select, or otherwise identify, apps for which data/content flow and/or presentation are to be managed by the avoidance manager platform 204 based on avoidance criteria. In various embodiments, the avoidance manager platform 204 may be configured to obtain (e.g., from an operating system and/or the like executing on the user device 202) information regarding available apps installed on the user device 202. In some embodiments, the avoidance manager platform 204 may communicate with such apps via respective application programming interfaces (APIs) and/or the like. In a case where an app allows for communication therewith (e.g., via an API), the avoidance manager platform 204 may provide a graphical representation of the app (e.g., in the form of an icon or the like) in the user interface 204i for user selection.

Referring to FIG. 2C, the avoidance manager platform 204 may cause the user device 202 to present a user interface 204j that enables a user to specify, or otherwise define, avoidance criteria for selected apps. As depicted in FIG. 2C, the user interface 204j may present a variety of criteria, such as criteria relating to topics (209t), criteria relating to the environment (209e), criteria relating to content type (209c), criteria relating to people and/or sources of information (209s), and/or the like. For instance, the user may specify topics, places or environments, types of data or content, persons, sources of information, and/or other types of criteria that define data or content for which the user wishes to avoid consuming (e.g., viewing, hearing, etc.) or physically interacting with. In some embodiments, the user may define new/custom avoidance criteria, such as a particular topic to be avoided, a particular type of content to be avoided, a particular brand/business (e.g., a particular restaurant chain, a particular hotel brand, a particular airline, and/or the like) to be avoided, a particular person to be avoided, a particular content source to be avoided, etc. In various embodiments, for each selected criterion, the user may specify (209u) whether the criterion should apply to one app, some apps, or all apps managed by the avoidance manager platform 204. As an example, in a case where the user selects “Violence” (e.g., violent content or the like) as being something that the user wishes to avoid, and selects to apply this to “All Apps,” then the avoidance manager platform 204 may apply such an avoidance criterion across all apps enabled for management by the avoidance manager platform 204. Continuing the example, the avoidance manager platform 204 may monitor a media content streaming app for streaming media determined to be (or otherwise tagged as) violent, a web browser (search) app for images determined (e.g., based on analysis by the avoidance manager platform 204 or the like) as being violent, a news app for news articles determined (e.g., based on analysis by the avoidance manager platform 204 or the like) as containing violence-related content, and so on. As another example, in a case where the user selects “Politics” as being something that the user wishes to avoid, and selects to apply this only to certain apps, such as a news app, then the avoidance manager platform 204 may monitor the news app, but not other apps, for political content. In one or more embodiments, a user may configure the avoidance manager platform 204 to apply avoidance criteria differently to different devices. For example, in a case where the avoidance manager platform 204 is implemented across multiple devices, such as a smartphone and a desktop computer, the user may configure the avoidance manager platform 204 to apply avoidance criteria to one device, but not another device (e.g., to prevent violent content from being presented on the smartphone, but where such content is permissible on the desktop computer). In some embodiments, the avoidance manager platform 204 may enable to a user choose whether to apply avoidance criteria differently on a particular device depending on the user who is determined (e.g., based on authentication credentials, based on facial recognition, and/or the like) to be accessing the particular device—e.g., where presentation of a certain topic is permissible via a social media app on a laptop device if a parent is accessing the laptop, but is to be avoided if a child is accessing the laptop.

In some embodiments, the avoidance manager platform 204 may require a user to provide authentication credentials (e.g., a password, biometric information, or the like) in order to access the user interfaces 204i and 204j and/or the avoidance manager platform 204 in general.

FIGS. 2D-2H are block diagrams illustrating example, non-limiting embodiments of respective systems 250-280 functioning within, or operatively overlaid upon, the system 200 of FIG. 2A and/or the communications network 100 of FIG. 1 in accordance with various aspects described herein. In various embodiments, one or more of the systems 250-280 may be the same as or similar to the system 200 of FIG. 2A.

Referring to FIG. 2D, as shown by reference number 210a, an app server 206, corresponding to a particular app installed on the user device 202, may provide data/content to the app. For example, the app server 206 may provide the data/content in the form of a data stream responsive to a request for data/content submitted by the app. As shown by reference number 210b, the avoidance manager platform 204 may obtain the data/content provided by the app server 206. The avoidance manager platform 204 may obtain the data/content from the app or, alternatively, intercept the data stream before the data stream is received at the app. In various embodiments, the avoidance manager platform 204 may additionally, or alternatively, obtain information regarding the data/content, such as metadata, data regarding a source of the data/content, and/or the like.

In exemplary embodiments, the avoidance manager platform 204 may analyze the data/content and/or the information regarding the data/content. For example, the avoidance manager platform 204 may perform various processing on the data/content and/or the information regarding the data/content, such as speech-to-text conversion processing, natural language processing, text-based processing, image-based processing (e.g., optical character recognition or image recognition processing on image or video signals), and/or the like.

In various embodiments, the avoidance manager platform 204 may, based on result(s) of the analysis, determine whether the data/content, or any portion thereof, satisfies the avoidance criteria selected or defined by the user. For example, in a case where the user configures (e.g., via the user interfaces 204i and/or 204j) the avoidance manager platform 204 to avoid data/content relating to politics, opinions, disputed facts, and/or extremist groups (as shown by reference number 209v of FIG. 2D), the avoidance manager platform 204 may determine whether any portion(s) of the data/content relate to politics, opinions, disputed facts, and/or extremist groups. If the avoidance manager platform 204 determines that the avoidance criteria are satisfied (e.g., that the data/content, or a portion thereof, relates to politics, opinions, disputed facts, and/or extremist groups), the avoidance manager platform 204 may prevent (210c) the app from presenting (210d) to the user any portion of the data/content that satisfies the avoidance criteria (e.g., any portion of the data/content that relates to politics, opinions, disputed facts, and/or extremist groups). In contrast, if the avoidance manager platform 204 determines that the avoidance criteria are not satisfied (e.g., that no portion of the data/content satisfies the avoidance criteria—that is, no portion of the data/content relates to politics, opinions, disputed facts, or extremist groups), then the avoidance manager platform 204 may permit (210c) the app to present (210d) the data/content (e.g., the entirety of the data/content) to the user.

In various embodiments, the avoidance manager platform 204 may permit the app to present portion(s) (e.g., only portion(s)) of the data/content that do not satisfy the avoidance criteria (e.g., that do not relate to politics, opinions, disputed facts, and/or extremist groups). For example, in a case where the app is a news app, where the avoidance criteria specifies that political content is to be avoided, and where the news app obtains a set of news articles that includes political content as well as other content, the avoidance manager platform 204 may permit the news app to present the other content, but not the political content. In some embodiments, the avoidance management platform 204 may prevent the app from presenting any of the data/content if any portion of the data/content satisfies the avoidance criteria. For instance, in the foregoing example, the avoidance manager platform 204 may prevent the news app from presenting any of the news articles.

In exemplary embodiments, the avoidance manager platform 204 may prevent an app from presenting portion(s) of data/content that satisfy avoidance criteria, by modifying or revising the data/content, or otherwise causing (210c) (e.g., by way of one or more instructions) the app to modify or revise the data/content, such that the portion(s) of the data/content are removed, deleted, or blocked from view, audible output, or the like when the remaining portion(s) of the data/content are presented. In this way, portion(s) of data/content, rather than an entirety of the data/content, may be selectively blocked. In various embodiments, the avoidance manager platform 204 may store blocked/removed content (e.g., on a different device, in a cloud account, or the like) for later access. In some embodiments, the avoidance manager platform 204 may cause image recognition processing, text recognition processing, audio recognition processing, or the like to be performed on such stored content, and a summary thereof or the like to be generated to facilitate user review of the blocked/removed content (e.g., to enable a user to verify avoidance accuracy or efficiency, etc.).

In some cases, modification or revision to data/content may visually or audibly distort the remaining portion(s) of the data/content when presented to the user. For example, in a case where an image containing violent content satisfies avoidance criteria and is to be blocked from image search results obtained by a web browser app, a visual presentation of the search results might be impacted, such as there being an empty area or the like in the presented search results where the image would otherwise have been presented. As another example, in a case where a political segment is to be blocked from a news video clip obtained by a news app, visual/audible presentation of the news video clip might be impacted, such as there being a blank screen and/or no audio during a portion of the news video clip when the political segment would otherwise have been presented.

Therefore, in various embodiments, the avoidance manager platform 204 may cause an app to provide, or otherwise insert, replacement data/content as a substitute for data/content that is to be removed or blocked. For example, in some embodiments, the avoidance manager platform 204 may cause the app to insert default or customized data/content (e.g., default or customized text, a default or customized image, a default or customized audio clip, a default or customized video clip, or the like) as a substitute for data/content that satisfies avoidance criteria and that is to be removed or blocked. In certain embodiments, the avoidance manager platform 204 may enable (e.g., via one or more user interfaces or the like) the user to predefine default or customized data/content for various data types—e.g., for example, a default song that the user wishes to use as a substitute for a portion of an audio segment that contains violent content, a different song that the user wishes to use as a substitute for a portion of an audio segment that contains political content, a customized video clip of simulated travel across a galaxy of stars that the user wishes to use as a substitute for a portion of a video segment that contains a certain television celebrity that the user wants to avoid, a blank (e.g., white, black, or other color) image or a photograph of the user's children to be used as a substitute for any image that satisfies avoidance criteria and that is to be removed or blocked, default text such as “Extremist Group-related content has been blocked by the avoidance manager platform,” and/or the like. In this way, the user may, based upon being presented with default or customized data/content, recognize that certain data/content received by the app has been removed or blocked. In some embodiments, the avoidance manager platform 204 may identify a type or nature of blocked content and utilize the type or nature (and/or a corresponding avoidance criteria/rule) to determine related but non-blocked content. For example, in a case where the avoidance manager platform 204 determines that a song or a visual is to be blocked in accordance with avoidance criteria (e.g., based on the user being located in a determined school zone), the avoidance manager platform 204 may substitute that song or visual with a similar song or visual by the same artist, creator, or provider. Continuing the example, the avoidance manager platform 204 may not substitute the song or visual with any other song or visual that has been marked for avoidance (e.g., based on previously-created content ratings, user-specified preferences, or the like). As another example, in a case where the avoidance manager platform 204 determines that video content includes alternate politics, disputed facts, certain types of content, or the like to be avoided based on avoidance criteria, the avoidance manager platform 204 may substitute such content with other related content (e.g., that may be determined by the avoidance manager platform 204 to be on the same topic, but is not designated as content to be blocked, such as, for example, non-disputed facts, politics from another region, etc.).

In certain embodiments, the avoidance manager platform 204 may additionally, or alternatively, cause a default or customized graphic to be overlayed on data/content that satisfies avoidance criteria. For example, in a case where the user configures the avoidance manager platform 204 to avoid political content, and where a web browser app obtains search results that include a political advertisement, the avoidance manager platform 204 may, based upon detecting such political advertisements, cause the web browser app to overlay a default or customized image, such as a blank white image or the like, on the political advertisement (e.g., without, or in addition to, actually altering the data/content to block or remove the political advertisement). In some embodiments, in relation to a digital world app 205b, for example, the avoidance manager platform 204 may replace content to be blocked or avoided (e.g., text, image, video, or the like) by substituting such content with alternate content (e.g., via uniform resource locators (URLs) of alternate content sources), where native presentation or playback methods may be utilized by the digital world app 205b to resize, stream, or the like the alternate content, as appropriate. In one or more embodiments, such a substitution may be executed as a modified playlist or, alternatively, implemented as a network-level redirect of transmitted data (e.g., emulating an original source identifier, but containing different data packets). In various embodiments, the avoidance manager platform 204 may require the digital world app 205b (or an underlying operating system that is running the app) to surface or present an additional content pane (e.g., a content or video player region, a sound mixer or overlay, etc.) that masks presented content and/or overrides control of the digital world app 205b at the operating system level on the user's behalf.

In some embodiments, the avoidance manager platform 204 may additionally, or alternatively, cause a visual presentation of data/content to be rearranged to accommodate for any portions of the data/content that are removed or blocked. For example, portions of text of a web-based article may be repositioned to occupy a location where a removed or blocked violent image would otherwise have been presented.

In various embodiments, the avoidance manager platform 204 may additionally, or alternatively, cause replacement data/content to be obtained from an app server 206 and used as a substitute for data/content that satisfies avoidance criteria, as described in more detail below with respect to the system 260 of FIG. 2E.

In one or more embodiments, in a case where a portion of a video/audio clip satisfies avoidance criteria and is to be removed or blocked, the avoidance manager platform 204 may cause the app to delete data corresponding to that portion of the video/audio clip, and stitch, or otherwise combine, the remaining portions of the video/audio clip. In some embodiments, the avoidance manager platform 204 may cause the app to include default data/content (e.g., similar to that described above) and stitch, or otherwise combine, the default data/content with the remaining portions of the video/audio clip.

In various embodiments, the avoidance manager platform 204 may cause the app to present a user selectable option (e.g., a button and/or the like), or to enable a user to choose (e.g., by way of voice-based input or the like), to reveal removed or blocked data/content. This permits, for example, the user to periodically check whether the avoidance manager platform 204 is properly removing or blocking data/content as anticipated, and allows the user to adjust the avoidance criteria selections as needed. In some embodiments, the app may present removed or blocked data/content responsive to receiving a user selection to reveal the removed or blocked data/content and/or based upon receiving instruction(s) from the avoidance manager platform 204 to reveal removed or blocked data/content. In certain embodiments, in a case where the data/content includes audio/video content, the avoidance manager platform 204 may wait until presentation of the audio/video content is complete prior to revealing removed or blocked data/content to the user.

In various embodiments, the avoidance manager platform 204 may perform the above-described analysis of data/content and management of presentation of such data/content to the user, for all applicable apps as dictated by the user's avoidance criteria selections. For example, in a case where the user chooses to apply avoidance criteria to certain apps or to all apps (e.g., politics for certain apps (e.g., a social media app and a news app), violence for a certain app (e.g., a media content streaming app), extremist groups for all apps, etc.), the above-described process relating to reference numbers 210a, 210b, 210c, and 210d may be performed for each of such apps based on the user's avoidance criteria selections. Continuing the example, the social media app and the news app may be permitted to present all content to the user other than political content; the media content streaming app may be permitted to present all content to the user other than violent content; and all apps may be permitted to present all content to the user (e.g., subject to constraints defined for each of the apps, such as no violent content for the media content streaming app, etc.) other than extremist group-related content.

In various embodiments, the avoidance manager platform 204 may, based on avoidance criteria, additionally monitor, analyze, and/or manage presentation of secondary data/content, such as advertisements or the like, which an app server 206 may retrieve from a third-party source and provide to the app or which the app server 206 may instruct the app to obtain from such a third-party source. Continuing the foregoing example, the avoidance manager platform 204 may remove or block political ads from the social media app and the news app.

In various embodiments, the avoidance manager platform 204 may provide an app server 206 with an opportunity to offer replacement data/content as a substitute for data/content that satisfies avoidance criteria and that is to be removed or blocked. In some embodiments, the avoidance manager platform 204 may provide the opportunity based on a user setting or selection. For example, the avoidance manager platform 204 may enable the user to select which apps (or corresponding app servers) may be given the opportunity to provide alternate content, which criteria (e.g., topics, types of content, environments, etc.) that, if satisfied, would trigger a request for alternate content, and/or the like. Referring to FIG. 2E, an app server 206 corresponding to a particular app may (e.g., similar to reference number 210a of FIG. 2D) provide (220a) data/content to the app. As shown by reference number 220b, the avoidance manager platform 204 may (e.g., similar to reference number 210b of FIG. 2D) obtain the data/content provided by the app server 206 and analyze the data/content and/or information regarding the data/content. In various embodiments, the avoidance manager platform 204 may, based on result(s) of the analysis, determine whether the data/content, or any portion thereof, satisfies the avoidance criteria selected or defined by the user. For example, in a case where the user configures the avoidance manager platform 204 to avoid data/content relating to politics, opinions, disputed facts, and/or extremist groups (as shown by reference number 209v), the avoidance manager platform 204 may determine whether any portion(s) of the data/content relate to politics, opinions, disputed facts, and/or extremist groups. If the avoidance manager platform 204 determines that the avoidance criteria are satisfied (e.g., that the data/content, or a portion thereof, relates to politics, opinions, disputed facts, and/or extremist groups), the avoidance manager platform 204 may (e.g., similar to reference number 210c of FIG. 2D) prevent (220c) the app from presenting to the user any of the data/content or any portion of the data/content that satisfies the avoidance criteria (e.g., any portion of the data/content that relates to politics, opinions, disputed facts, and/or extremist groups).

In various embodiments, the avoidance manager platform 204 may (e.g., in contrast to reference number 210c of FIG. 2D) instruct the app to submit (220d) a request to the app server 206 for alternate content (220e) as a substitute for the data/content that satisfies avoidance criteria and that is to be removed or blocked. In some embodiments, the avoidance manager platform 204 may instruct the app to include, in the request, some or all of the avoidance criteria (e.g., in accordance with user opt-in/permissions or the like) to facilitate the app server 206 in identifying suitable, alternate data/content (e.g., that does not satisfy the avoidance criteria) to present (220f) to the user. In certain embodiments, the avoidance manager platform 204 may not instruct the app to include avoidance criteria in the request to the app server 206 (e.g., for user privacy reasons or the like), but may rather perform an analysis of any alternate content provided by the app server 206 against the avoidance criteria (e.g., in a manner similar to that described above). In such embodiments, the avoidance manager platform 204 may repeat this process until suitable, alternate data/content (e.g., that does not satisfy the avoidance criteria) is provided by the app server 206. In some embodiments, the avoidance manager platform 204 may be configured to limit such a back-and-forth request-and-retrieval of alternate content—e.g., by halting requesting/retrieval of alternate content based on a threshold being satisfied (e.g., based on a total quantity of times that alternate content is requested and retrieved for a given data communication session, based on a time limit, and/or the like), so as to avoid delaying presentation of data/content to the user.

In some cases, portion(s) of data/content for which alternate content is to be requested may include advertising content. For example, where a user configures the avoidance manager platform 204 to avoid political content, the avoidance manager platform 204 may identify political advertising content provided by the app server 206, or by another third-party source, for removal or blocking. In such cases, the avoidance manager platform 204 may instruct (e.g., at 220c) the app to include, in the above-described alternate content request, advertising preferences (e.g., in accordance with user opt-in/permissions or the like) to facilitate the app server 206 or the third-party source in identifying suitable, alternate advertising content (220e) (e.g., that does not satisfy the avoidance criteria) to present (220f) to the user. In various embodiments, the avoidance manager platform 204, the app server 206, and/or the third party source may be communicatively coupled with one or more ad tech systems (including, e.g., bidding system(s), etc.) that facilitate real-time auction(s), where line items or predetermined requirements are utilized, such as in conjunction with user avoidance criteria, to facilitate delivery of advertising to the user. In instances where the app server 206 or the third-party source is to substitute second advertising content for first advertising content that satisfies avoidance criteria, and where a cost (e.g., a bid price) relating to the second advertising content is less than that for the first advertising content, the app server 206 or the third-party source may wish to be compensated for such a substitution. In such instances, the avoidance manager platform 205 may (e.g., based upon a request by the app server 206 or the third-party source) permit the app server 206 or the third-party source to submit additional advertising content (e.g., such as two or more advertisements) to avoid lost revenue for the app server 206 or the third-party source. In various embodiments, in a case where such additional advertising content are used as substitutes, the avoidance manager platform 204 may cause the device to provide a notification thereof to the user (including, for example, an offer for the user to adjust the avoidance criteria—e.g., “You can decrease the number of ads by permitting political content . . . ” or the like).

In various embodiments, the avoidance manager platform 204 may provide alerts or notifications to the user regarding data/content that has been removed or blocked in accordance with avoidance criteria. Referring to FIG. 2F, an app server 206 corresponding to a particular app may (e.g., similar to reference number 210a of FIG. 2D) provide (230a) data/content to the app. As shown by reference number 230b, the avoidance manager platform 204 may (e.g., similar to reference number 210b of FIG. 2D) obtain the data/content provided by the app server 206 and analyze the data/content and/or information regarding the data/content. In various embodiments, the avoidance manager platform 204 may, based on result(s) of the analysis, determine whether the data/content, or any portion thereof, satisfies the avoidance criteria selected or defined by the user. For example, in a case where the user configures (e.g., as shown by reference number 209w of FIG. 2F) the avoidance manager platform 204 to avoid certain undesirable physical environment conditions, such as high crime areas, crowded places or locations, loud settings or environments afflicted with high levels of noise (e.g., from vehicular traffic and honking, from nearby construction work, from marine traffic near harbors, etc.), environments with particular physical characteristics (e.g., large changes in elevation that may inhibit mobility for an elderly visitor), environments with numerous facility lines (e.g., electrical, phone, or overhead lines that may obscure a scenic tour of a city, such as San Francisco), locations or environments that have anomalous conditions as described by one or more other data providers (e.g., a region having high allergens, pollutants, or humidity, as reported by a weather service), environments that self-report certain demographic trends during a day (e.g., a park where many children may be present before Noontime, but where many teenagers may be present after 8 PM or the like), or the like and/or to avoid people who have undesirable user preferences, such as rival sports team fans or the like, the avoidance manager platform 204 may determine whether any portion(s) of the data/content relate to environments associated with high crime, environments that have crowds, loud settings, people who are fans of a rival sports team, etc. If the avoidance manager platform 204 determines that the avoidance criteria are satisfied, the avoidance manager platform 204 may prevent (230c) the app from presenting (230d) any portion of the data/content that satisfies the avoidance criteria (e.g., any portion of the data/content that relates to environments associated with high crime, environments that have crowds or involve loud settings (e.g., based upon levels of crowdedness and/or noise satisfying one or more thresholds, such as being above the threshold(s)), people who are fans of a rival sports team, etc.).

Alternatively, the avoidance manager platform 204 may nevertheless permit (230c) the app to present (230d) to the user any portion of the data/content that satisfies the avoidance criteria (e.g., any portion of the data/content that relates to environments associated with high crime, environments that have crowds, loud settings, people who are fans of a rival sports team, etc.), but the avoidance manager platform 204 may provide, or cause the app to provide, one or more alerts or notifications relating to the data/content that satisfies the avoidance criteria, so that the user may be made aware of such data/content. The alerts or notifications may be presented in any suitable manner, including, for example, visually (e.g., via a pop-up message and/or by lighting up, blinking, or changing a color of an icon or a window used to present data/content, etc.), audibly (e.g., via an output of an audible tone, speech, etc.), haptically, and/or the like. As an example, assume that a user is planning a trip using a navigation app (e.g., for directions), a ridesharing app (e.g., for a ride), and/or a hotel app (e.g., for making a reservation). In this example, the avoidance manager platform 204 may provide notifications to the user based on data/content obtained and presented by such apps to alert the user to any avoidance criteria that are satisfied. For instance, the navigation map may be permitted to present segments of a travel route that traverse determined high crime areas, but may present a notification to alert the user to such segments of the travel route (including, for example, by highlighting, encircling, or the like the relevant segments of the travel route); the hotel app may present available hotels in determined high crime areas, but may present a notification to alert the user to such hotels (including, for example, by highlighting, encircling, or the like the hotels determined to be located in high crime areas); and/or the ridesharing app may, e.g., based upon determining that a driver's profile indicates that the driver is a fan of a rival sports team of the user, present a notification to alert the user to the driver's sports team preference and/or an option to select a different driver to service the user. In certain embodiments, the avoidance manager platform 204 may prevent certain data/content, such as navigation directions that correspond to segments of a travel route that correspond to determined high crime areas, from being presented to the user, and may alert the user to such data/content and/or enable the user to optionally reveal that data/content as desired.

As another example, assume that a user is searching for a restaurant using a web browser or restaurant app. In a case where the app server 206 corresponding to the web browser or restaurant app provides information (e.g., real-time or historical information, such as video/audio sensor data or manual feedback provided by the restaurants or other users (or their user devices) located at or near the restaurants) regarding determined crowdedness and/or high noise levels or loudness in an environment of one or more restaurants in a results list, the web browser or restaurant app may present a notification to alert the user to such determined crowdedness and/or high noise levels. In various embodiments, the avoidance manager platform 204 and/or the app may cause a notification to be provided based upon levels of crowdedness and/or noise satisfying one or more thresholds (e.g., being above the threshold(s)).

As a further example, assume that a user is attending a social event, such as a party or a convention, and wishes to avoid political content (or engaging in discussions relating to politics), interacting with or being near anyone who is a fan of a rival sports team of the user, and/or interacting with or being near a particular person/contact (e.g., by selecting avoidance criteria as shown by reference number 209x of FIG. 2G). Continuing the example, in a case where the particular person/contact makes their presence known, such as via a public post, or by publicly “checking in,” on social media or the like, the avoidance manager platform 204 may communicate with an app on the user device 202, such as a social media app, a web browser app, or the like, to determine the particular person's/contact's whereabouts, and cause a notification to be provided to the user (e.g., via the social media app, the web browser app, or the like) to alert the user to nearby presence of the particular person/contact (e.g., if the particular person/contact is determined to be located within a threshold distance from the user). Further continuing the example, in a case where various people make their presence (e.g., location) and interests (e.g., preferred sports teams, political parties, etc.) known, such as via social media or the like, the avoidance manager platform 204 may communicate with an app on the user device 202, such as a social media app, a web browser app, or the like, to determine whether people who are fans of rival sports teams, for example, are nearby, and cause a notification to be provided to the user (e.g., via the social media app, the web browser app, or the like) to alert the user to nearby presence of such people (e.g., if such people are determined to be located within a threshold distance from the user). Still continuing the example, in a case where various people make their presence (e.g., location) known, where audio input device (e.g., microphone) data is accessible (e.g., from user equipment of such people or from other nearby devices), and where such microphone data is made available to social media, conversation apps, or the like, the avoidance manager platform 204 may communicate with an app on the user device 202, such as a social media app, a conversation app, or the like, to determine whether certain discussions (e.g., based on identified words, themes, or the like in conversations captured by the microphone(s)) relate to politics, and if so, cause a notification to be provided to the user (e.g., via the social media app, the conversation app, or the like) to alert the user to location(s) where such conversation(s) are taking place.

In various embodiments, the avoidance manager platform 204 may determine a likely travel route of the user (e.g., based on monitoring the user's calendar data and/or travel data (e.g., itinerary information or the like)), detect (e.g., in real-time or near real-time) presence of undesired contacts, such as a specified person/contact or rival sports team fan(s), along the travel route (e.g., within a threshold distance of portions of the travel route), and cause information regarding detected presence of such undesired contacts to be presented (e.g., on a map or the like) to the user to enable the user to traverse a different travel route to avoid the undesired contacts as needed.

In this way, embodiments of the avoidance manager platform 204 provide a mechanism that allows a user to define and use a common (or the same) set of criteria, across multiple apps, for avoiding content (e.g., political content or discussions, etc.), contacts (e.g., certain people (whether in person, on social media, by phone, via a chat app, etc.), people with certain preferences (whether in person, on social media, etc.), and/or the like), and other subject matter or situations when interacting in both the physical and digital worlds, which enhances overall avoidance management and obviates a need for the user to separately modify individual app settings (assuming that such modifications are even possible in such apps).

Referring to FIG. 2H, an app server 206 corresponding to a particular app may (e.g., similar to reference number 210a of FIG. 2D) provide (240a) data/content to the app. As shown by reference number 240b, the avoidance manager platform 204 may (e.g., similar to reference number 210b of FIG. 2D) obtain the data/content provided by the app server 206 and analyze the data/content and/or information regarding the data/content. In various embodiments, the avoidance manager platform 204 may, based on result(s) of the analysis, determine whether the data/content, or any portion thereof, satisfies the avoidance criteria selected or defined by the user. If the avoidance manager platform 204 determines that the avoidance criteria are satisfied, the avoidance manager platform 204 may permit (240c) the app to present (240d) to the user any portion of the data/content that satisfies the avoidance criteria, but the avoidance manager platform 204 may (e.g., in addition to causing the app server 206 to provide alternate content as described above with respect to the system 260 of FIG. 2E, or without causing the app server 206 to provide alternate content) cause the data/content to be modified or otherwise filtered prior to being presented to the user. For instance, in a case where a navigation app obtains navigation directions in which a segment of a travel route traverses a determined high crime area (209y), the avoidance manager platform 204 may cause the navigation app to identify and present navigation directions for a different route that avoids the high crime area. As another example, in a case where a hotel app obtains a listing of hotels that includes hotel(s) located in a determined high crime area, the avoidance manager platform 204 may cause the hotel app to modify or revise the listing of hotels—e.g., by flagging hotels that are located in determined high crime areas, removing such hotels from the listing, and/or the like. As a further example, in a case where a ridesharing app obtains information regarding drivers that are available to pick up the user, and where the avoidance manager platform 204 determines (e.g., based on the drivers' profiles) that a particular driver is a fan of a rival sports team of the user (209y), the avoidance manager platform 204 may cause the ridesharing app to select, or present information regarding, a different driver to service the user.

In various embodiments, the avoidance manager platform 204 can employ machine learning algorithm(s) that are configured to learn a user's behavior or preferences relating to avoidance and automatically adjust (e.g., over time) avoidance criteria accordingly. For example, the machine learning algorithm(s) may learn the user's preferred avoidance customizations relating to topics, content type, environments, people/contacts, content source, and/or the like (e.g., which removed or blocked content types that the user tends to wish to have revealed; updates to avoidance criteria (e.g., such as choosing to block political content on certain days of the week or during certain times of the day and choosing to re-block political content otherwise); updates to which avoidance criteria apply to which apps installed on the user device 202; etc.). In various embodiments, the avoidance manager platform 204 may adjust, based on the learned information, future actions performed by, or outputs provided by, the avoidance manager platform 204 to enhance the user's overall avoidance management experience. For example, in some embodiments, the avoidance manager platform 204 may provide information regarding a user's preferences or behavior as input to one or more machine learning algorithms, which may perform machine learning to automate future determinations or predictions of user preferences or behavior. For instance, the avoidance manager platform 204 may train a machine learning algorithm based on known inputs (e.g., removal or blocking of content based on avoidance criteria, etc.) and known outputs (e.g., the user choosing to reveal removed or blocked content and/or adjusting of avoidance criteria, etc.). In some embodiments, the avoidance manager platform 204 may refine a machine learning algorithm based on feedback received from a user of the avoidance manager platform 204 and/or from one or more other devices (e.g., management device(s)). For example, the user of the avoidance manager platform 204 and/or one or more management devices may provide feedback indicating whether predictions of user preferences or behavior, made by the machine learning algorithm based on new inputs, are accurate and/or helpful. When the feedback indicates that a particular prediction is accurate and/or helpful, the avoidance manager platform 204 may configure the machine learning algorithm to make predictions of user preferences or behavior based on the particular prediction (e.g., to predict user preferences or behavior in a manner similar to that in which the particular prediction was made). When the feedback indicates that a particular prediction is not accurate or helpful, the avoidance manager platform 204 may configure the machine learning algorithm to avoid predicting user preferences or behavior in a manner in which the particular prediction was made. In this way, the avoidance manager platform 204 can predict user preferences or behavior based on one or more machine learning algorithms, which improves the accuracy of the predictions, and conserves processor and/or storage resources that may otherwise be used to generate and store rules for predicting user preferences or behavior.

Although the avoidance manager platform 204 is described above as being configured to provide overall avoidance management of apps with regard to controlling presentation of data/content, in some embodiments, the avoidance manager platform 204 may alternatively delegate some or all of the above-described avoidance functionalities (such as analyzing data/content to be transmitted to, or to be presented on, the user device 202, removing/blocking portions of data/content, etc.) to the app(s) and/or corresponding app server(s) 206. For example, in some embodiments, the avoidance manager platform 204 may provide a user's avoidance criteria (e.g., as user avoidance profile data) to the app(s) to enable the app(s) and/or corresponding app server(s) 206 to perform some or all of the above-described avoidance functionalities or to perform similar avoidance functionalities. In cases where a user's avoidance criteria are provided to the corresponding app server(s) 206, for example, avoidance management may be simplified given that the corresponding app server(s) 206 can determine (e.g., beforehand), in accordance with the user's avoidance preferences (which may have been stored in the user's profile on the app server(s)), the types of data/content that should and should not be selected and/or transmitted to the apps to present to the user, which can reduce or eliminate a need for data/content analysis, etc. by the apps or the avoidance manager platform 204.

Furthermore, in various embodiments, the avoidance manager platform 204 may be configured to monitor user inputs (e.g., user utterances, user facial expressions, and/or the like detected via one or more audio/image capturing devices of the user device 202), and automatically adjust avoidance criteria based on the user inputs. For example, in a case where a web browser app presents a web page that includes multiple car advertisements, and where the avoidance manager platform 204 detects user discontentment with the car advertisements (e.g., detects the user uttering “I hate car ads” or the like; detects a frown on the user's face as the user is scrolling past a car ad; and/or the like), the avoidance manager platform 204 may adjust the user's avoidance criteria accordingly (e.g., by defining car advertisements or the like as content to be avoided) and applying the updated avoidance criteria to one or more apps. Other examples may include disabling a part of an app or device (e.g., turning off a screen in the middle of a broadcast or advertisement), muting a region or portion of content, switching tracks/playback to an alternate source or content, or disabling or closing the app and switching to another app or activity on the device. In some embodiments, in cases relating to avoidance of physical entities (e.g., certain people, certain places, etc.), a user may change course (e.g., via navigation) or a presence time (e.g., to avoid being present or dwelling at a business, a location, proximate to a person or a place, etc.) to indicate the user's dissatisfaction with local conditions. In such embodiments, the avoidance manager platform 204 may, based upon detecting such user action, (e.g., passively) adapt avoidance criteria/rules accordingly or actively solicit the user to validate/confirm avoidance criteria/rules and/or any needed updates or changes thereto.

In various embodiments, the avoidance manager platform 204 may (e.g., using machine learning algorithm(s)) determine or recommend replacement content or adjustments to content responsive to identifying avoidance criteria being satisfied. In some embodiments, the avoidance manager platform 204 may determine or recommend such replacement content or adjustments to content based on detected user utterances, facial expressions, or the like—e.g., recommend certain replacement content based on detecting a user's utterance, determine an adjustment to content based on detecting a certain facial expression, cause a blank image to be presented or overlaid on content to be avoided, etc.

In various embodiments, the avoidance manager platform 204 may be configured to monitor for or identify new user device(s) (e.g., based on detecting a new user device establishing a connection with the network 208, based on detecting syncing or pairing of a new user device with an existing user device, and/or the like) and/or new app(s) being installed or accessed on user devices, and provide recommendations for, or automatically apply, avoidance criteria to the new user device(s) and/or app(s).

In various embodiments, the avoidance manager platform 204 may (e.g., using machine learning algorithm(s)) apply avoidance criteria differently depending on the user device, the user (including, for example, user historical behavior or the like), and/or the app. For example, the avoidance manager platform 204 may recognize that a first user (e.g., a parent) repeatedly accesses avoided political content on a laptop device, but not on a mobile phone, whereas a second user (e.g., a child) does not access avoided political content on the same laptop device. Continuing the example, the avoidance manager platform 204 may, based upon such a recognition, determine to reconfigure (or recommend a reconfiguration of) avoidance criteria settings on the mobile phone (e.g., such that political content is permitted to be presented on the mobile phone). Further continuing the example, the avoidance manager platform 204 may determine to adaptively reconfigure (or recommend an adaptive reconfiguration of) avoidance criteria settings on the laptop device—e.g., where the avoidance of political content is not applied when the first user is determined to be using the laptop device, but where the avoidance of political content is applied when the second user is determined to be using the laptop device.

It is to be understood and appreciated that, although embodiments of the avoidance manager platform 204 are described herein as being capable of managing data/content flow and/or presentation based on avoidance criteria, the manager platform can alternatively be capable of managing data/content flow and/or presentation based on permission criteria or the like. Further, although various examples of avoidance management are described herein as involving avoidance criteria (e.g., multiple criterion) being satisfied, it is to be understood and appreciated that “criteria” may include one or more criterion, such as in cases where an avoidance criterion (e.g., only a single avoidance criterion) is configured, applicable, or satisfied.

It is also to be understood and appreciated that, although FIGS. 2A-2H are described above as pertaining to various processes and/or actions that are performed in a particular order, some of these processes and/or actions may occur in different orders and/or concurrently with other processes and/or actions from what is depicted and described above. Moreover, not all of these processes and/or actions may be required to implement the systems and/or methods described herein.

FIG. 2J depicts an illustrative embodiment of a method 290 in accordance with various aspects described herein. In some embodiments, one or more process blocks of FIG. 2J can be performed by an avoidance manager platform, such as the avoidance manager platform 204. In some embodiments, one or more process blocks of FIG. 2J may be performed by another device or a group of devices separate from or including the avoidance manager platform 204, such as the user device 202, one or more app servers 206, and/or the network 208.

At 290a, the method can include receiving a user input that defines an avoidance rule and that associates the avoidance rule with a plurality of applications installed on a user device, wherein the avoidance rule relates to content. For example, the avoidance manager platform 204 can receive a user input that defines an avoidance rule and that associates the avoidance rule with a plurality of applications installed on a user device in a manner similar to that described above with respect one or more of the systems 200 and 250-280 of FIGS. 2A-2H, where the avoidance rule relates to content.

At 290b, the method can include associating the avoidance rule with the plurality of applications responsive to the receiving the user input. For example, the avoidance manager platform 204 can associate the avoidance rule with the plurality of applications responsive to the receiving the user input in a manner similar to that described above with respect one or more of the systems 200 and 250-280 of FIGS. 2A-2H.

At 290c, the method can include monitoring, according to the avoidance rule, data received at the plurality of applications. For example, the avoidance manager platform 204 can monitor, according to the avoidance rule, data received at the plurality of applications in a manner similar to that described above with respect one or more of the systems 200 and 250-280 of FIGS. 2A-2H.

At 290d, the method can include, based on detecting, from the monitoring, that a first portion of first data received at a first application of the plurality of applications satisfies the avoidance rule, preventing the first application from presenting the first portion of the first data on the user device. For example, the avoidance manager platform 204 can, based on detecting, from the monitoring, that a first portion of first data received at a first application of the plurality of applications satisfies the avoidance rule, prevent the first application from presenting the first portion of the first data on the user device in a manner similar to that described above with respect one or more of the systems 200 and 250-280 of FIGS. 2A-2H.

At 290e, the method can include, based on identifying, according to information received at the first application or a second application of the plurality of applications, that a discussion or event occurring at a geographic location satisfies the avoidance rule, causing a first notification regarding the discussion or event to be presented by the user device to enable a user of the user device to avoid the discussion or event. For example, the avoidance manager platform 204 can, based on identifying, according to information received at the first application or a second application of the plurality of applications, that a discussion or event occurring at a geographic location satisfies the avoidance rule, cause a first notification regarding the discussion or event to be presented by the user device to enable a user of the user device to avoid the discussion or event in a manner similar to that described above with respect one or more of the systems 200 and 250-280 of FIGS. 2A-2H.

While for purposes of simplicity of explanation, the respective processes are shown and described as a series of blocks in FIG. 2J, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

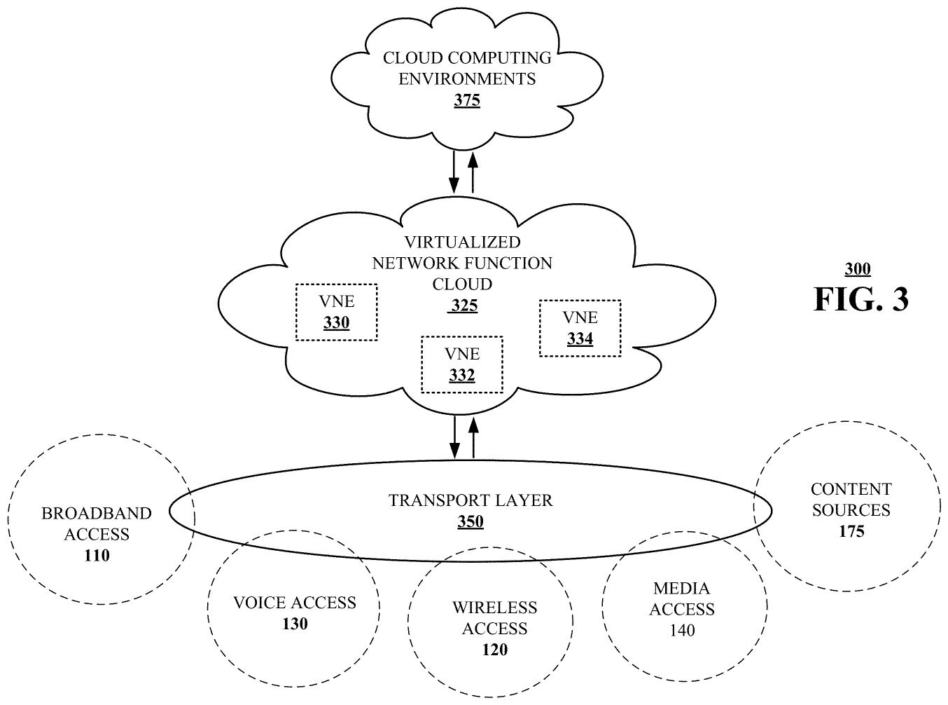

Referring now to FIG. 3, a block diagram 300 is shown illustrating an example, non-limiting embodiment of a virtualized communications network in accordance with various aspects described herein. In particular, a virtualized communications network is presented that can be used to implement some or all of the subsystems and functions of system 100, the subsystems and functions of system 200, systems 250-280, and method 290 presented in FIGS. 1 and 2A-2J. For example, virtualized communications network 300 can facilitate, in whole or in part, providing avoidance management for a user in physical and/or digital environments based on avoidance criteria.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements—which are typically integrated to perform a single function, the virtualized communications network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general purpose processors or general purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it's elastic: so the resources are only consumed when needed. In a similar fashion, other network elements such as other routers, switches, edge caches, and middle-boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized, and might require special DSP code and analog front-ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements don't typically need to forward large amounts of traffic, their workload can be distributed across a number of servers—each of which adds a portion of the capability, and overall which creates an elastic function with higher availability than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud, or might simply orchestrate workloads supported entirely in NFV infrastructure from these third party locations.

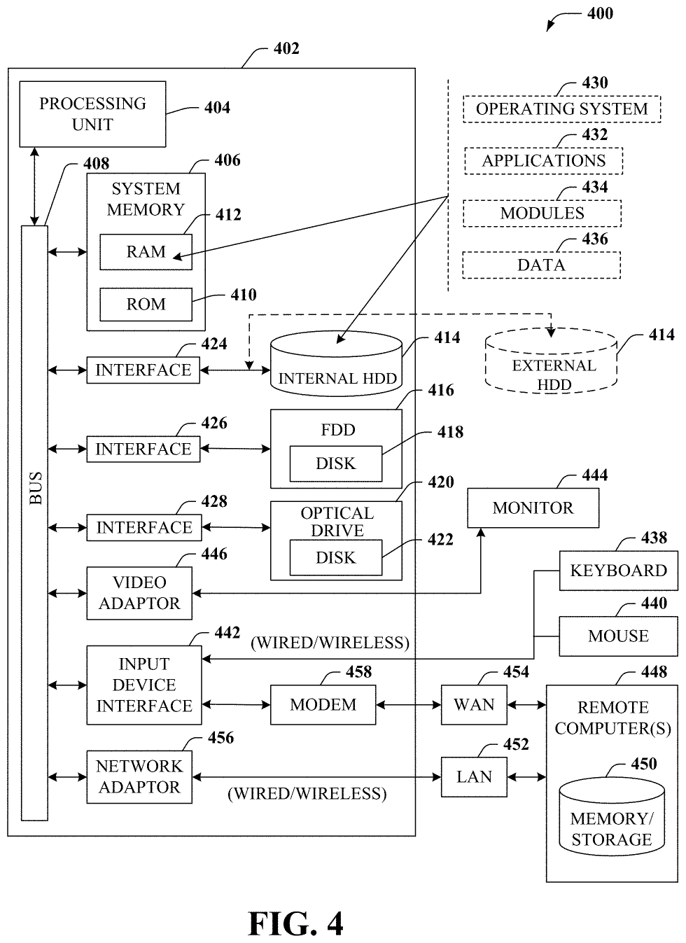

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate, in whole or in part, providing avoidance management for a user in physical and/or digital environments based on avoidance criteria.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communications network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

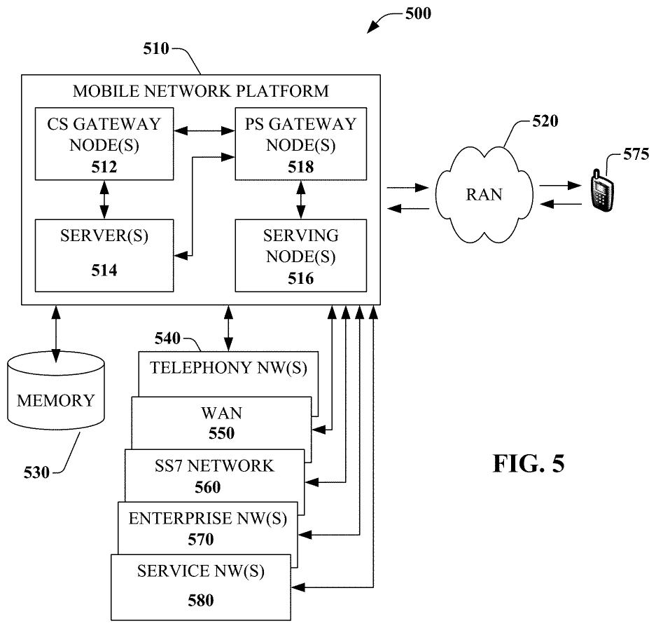

Turning now to FIG. 5, an embodiment 500 of a mobile network platform 510 is shown that is an example of network elements 150, 152, 154, 156, and/or VNEs 330, 332, 334, etc. For example, platform 510 can facilitate, in whole or in part, providing avoidance management for a user in physical and/or digital environments based on avoidance criteria. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks, and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as distributed antenna networks that enhance wireless service coverage by providing more network coverage.

It is to be noted that server(s) 514 can comprise one or more processors configured to confer at least in part the functionality of mobile network platform 510. To that end, the one or more processor can execute code instructions stored in memory 530, for example. It is should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

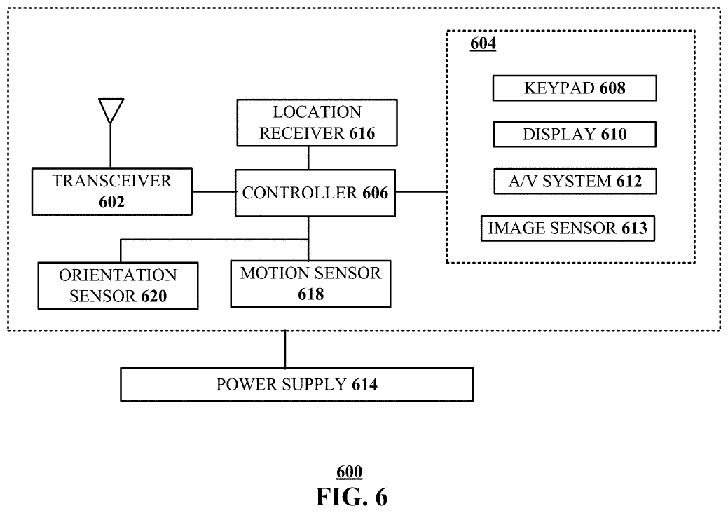

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate, in whole or in part, providing avoidance management for a user in physical and/or digital environments based on avoidance criteria.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, WiFi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, WiFi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communications network) can employ various AI-based schemes for carrying out various embodiments thereof. Moreover, the classifier can be employed to determine a ranking or priority of each cell site of the acquired network. A classifier is a function that maps an input attribute vector, x=(x1, x2, x3, x4, . . . , xn), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communications network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
a processing system including a processor; and
a memory that stores executable instructions that, when executed by the processing system, facilitate performance of operations, the operations comprising:
receiving a user input that defines an avoidance criterion, wherein the avoidance criterion relates to an undesirable physical environment condition, and wherein the avoidance criterion is usable to restrict content, relating to physical locations that have the undesirable physical environment condition, from being presented on the device;
associating the avoidance criterion with a plurality of applications installed on the device;
detecting first content received at a first application of the plurality of applications;
analyzing the first content responsive to the detecting the first content;
determining, based on the analyzing the first content, that a first portion of the first content satisfies the avoidance criterion; and
preventing the first application from presenting the first portion of the first content on the device based on the determining that the first portion of the first content satisfies the avoidance criterion.

2. The device of claim 1, wherein the operations further comprise:
detecting second content received at a second application of the plurality of applications, wherein the second application is distinct from the first application;
analyzing the second content responsive to the detecting the second content;
determining, based on the analyzing the second content, that the second content does not satisfy the avoidance criterion; and
permitting the second application to present the second content on the device based on the determining that the second content does not satisfy the avoidance criterion.

3. The device of claim 1, wherein the operations further comprise receiving a second user input to associate the avoidance criterion with the plurality of applications, and wherein the associating the avoidance criterion with the plurality of applications is based on the receiving the second user input.

4. The device of claim 1, wherein the first content relates to a first physical location, wherein the analyzing comprises obtaining first physical environment condition information relating to the first physical location, and wherein the determining is based on the first physical environment condition information.

5. The device of claim 1, wherein the operations further comprise causing the first application to present modified content that excludes the first portion of the first content.

6. The device of claim 1, wherein the first content is received at the first application from a first application server, and wherein the operations further comprise, based on the determining that the first portion of the first content satisfies the avoidance criterion, causing the first application to request, from the first application server, alternate content as a substitute for the first portion of the first content.

7. The device of claim 1, wherein the undesirable physical environment condition relates to crime, crowdedness, noise level, or a combination thereof.

8. The device of claim 7, wherein the undesirable physical environment condition comprises a high rate of crime, wherein the first content comprises navigational directions to a destination location, and wherein the determining that the first portion of the first content satisfies the avoidance criterion comprises determining that a route associated with the navigational directions traverses a geographic area that is determined to have a high rate of crime.

9. The device of claim 7, wherein the undesirable physical environment condition comprises crowdedness or a high level of noise, wherein the first content comprises a listing of hospitality-related locations, and wherein the determining that the first portion of the first content satisfies the avoidance criterion comprises determining that a first hospitality-related location included in the listing of hospitality-related locations is associated with determined crowdedness or a determined high level of noise.

10. The device of claim 1, wherein the operations further comprise causing the device to output an alert regarding the determining that the first portion of the first content satisfies the avoidance criterion.

11. A non-transitory machine-readable medium, comprising executable instructions that, when executed by a processing system of a user device including a processor, facilitate performance of operations, the operations comprising:
detecting a user input that defines an avoidance rule, wherein the avoidance rule relates to a first contact, and wherein the avoidance rule is usable to identify a physical presence of the first contact and to prevent data associated with the first contact from being presented on the user device;
associating the avoidance rule with a plurality of applications installed on the user device;
based on identifying, according to information received at a first application of the plurality of applications, the physical presence of the first contact within a threshold distance from the user device, causing a first notification regarding the first contact to be presented on the user device to enable a user of the user device to avoid the first contact; and
based on determining that first data, received at the first application or at a second application of the plurality of applications, is associated with the first contact, preventing the first data from being presented on the user device.

12. The non-transitory machine-readable medium of claim 11, wherein the plurality of applications comprises a social media application, a conversation application, a phone application, a messaging application, a web browser application, or a combination thereof.

13. The non-transitory machine-readable medium of claim 11, wherein the avoidance rule further relates to an undesirable user preference, and wherein the operations further comprise, based on determining that particular data received at a particular application of the plurality of applications relates to a particular contact that is associated with the undesirable user preference, causing a second notification regarding the particular contact to be presented on the user device to enable the user of the user device to avoid the particular contact.

14. The non-transitory machine-readable medium of claim 13, wherein the particular application comprises a ridesharing application, and wherein the particular contact comprises a driver of a vehicle that is available to provide service for the user.

15. The non-transitory machine-readable medium of claim 13, wherein the undesirable user preference comprises a preference for a rival sports team of the user.

16. A method, comprising:
receiving, by a processing system of a user device including a processor, a user input that defines an avoidance rule and that associates the avoidance rule with a plurality of applications installed on the user device, wherein the avoidance rule relates to content;
associating, by the processing system, the avoidance rule with the plurality of applications responsive to the receiving the user input;
monitoring, by the processing system according to the avoidance rule, data received at the plurality of applications;
based on detecting, from the monitoring, that a first portion of first data received at a first application of the plurality of applications satisfies the avoidance rule, preventing, by the processing system, the first application from presenting the first portion of the first data on the user device; and
based on identifying, according to information received at the first application or a second application of the plurality of applications, that a discussion or event occurring at a geographic location satisfies the avoidance rule, causing, by the processing system, a first notification regarding the discussion or event to be presented by the user device to enable a user of the user device to avoid the discussion or event.

17. The method of claim 16, wherein the first data is received at the first application from an application server, and wherein the method further comprises causing, by the processing system and based on the detecting, the first application to obtain alternate content from the application server as a substitute for the first portion of the first data.

18. The method of claim 16, wherein the avoidance rule relates to violent content, political content, opinions, disputed facts, negative news, a content source, or a combination thereof, and wherein the method further comprises detecting a user action associated with particular content, determining that a particular avoidance rule should be defined based on the user action, and defining the particular avoidance rule based on the determining.

19. The method of claim 16, wherein the plurality of applications comprises a news application, a media content streaming application, a social media application, a web browser application, or a combination thereof.

20. The method of claim 16, wherein the preventing the first application from presenting the first portion of the first data comprises causing the first application to overlay an object on the first portion of the first data to block the first portion of the first data from being presented.
